(19) United States
(12) Patent Application Publication
(10) Pub. No.: US 2021/0331759 A1
(43) Pub. Date: Oct. 28, 2021

(54) A Mount for Portable Electronic Devices

(71) Applicant: TomTom International B.V., Amsterdam (NL)

(72) Inventors: Nicholas Alexander Evans, Amsterdam (NL); Mark Lee Dempsey, Amsterdam (NL); Daniel Browning, Amsterdam (NL); Andreas Schuh, Amsterdam (NL)

(21) Appl. No.: 16/325,714

(22) PCT Filed: Aug. 31, 2017
(86) PCT No.: PCT/EP2017/071852

§ 371 Date: Feb. 14, 2019

(30) Foreign Application Priority Data
Aug. 31, 2016 (GB) 1614739.9

(51) Int. Cl. B62J 45/20; F16C 11/10; F16M 13/02

(52) U.S. Cl. CPC B62J 45/20; F16M 13/022; F16C 11/103

(57) ABSTRACT

A mount assembly for a portable electronic device, comprising: a first component including a receiving surface arranged to engage against a surface of a portable electronic device; a second component including a mounting surface arranged to engage with a carrier; and a third component including a first surface that cooperates with a surface of the first component to allow the first component to rotate relative to the third component; and a second surface that cooperates with a surface of the second component to allow the third component to tilt relative to the second component. The mount assembly further comprises a locking member connecting the first and third components such that the first component moves with the third component when the third component tilts relative to the second component and that, when in a locked position, is arranged to prevent the relative movement between the first, second and third components.

### FIELD OF INVENTION

The present invention relates to a mount assembly for a portable electronic device such as a mobile phone, smart phone, PDA, portable audio system, multimedia player, portable navigation device or a display device. In embodiments, the invention is more specifically described in relation to a mount assembly for a display associated with a portable navigation device or a smart phone and configured for use with e.g. a motorcycle, scooter or the like.

### BACKGROUND OF THE INVENTION

There is a growing number of portable electronic devices which are capable of displaying information on a display device in a number of orientations, e.g. a portrait orientation, a landscape orientation, etc., and that often display different information depending on the orientation of the electronic device. One such type of portable electronic device is a navigation device, designed to be mounted on or within vehicles. Such devices provide functionality such as navigation, route planning, traffic updates, etc. Various mounting solutions have been developed that can support a portable electronic device in a number of different orientations, although often the user is required to remove the device from the mount before it can be docked again in a different orientation. These problems with known mounting solutions are a particular issue when mounting a portable electronic device, such as a navigation device, to a motorcycle or other similar type of vehicles like scooters, mopeds, etc.

There are further issues that need to be considered when electronic devices are mounted on motorcycles, scooters and the like as these devices, when mounted, and their mounts are not then enclosed within a vehicle but, rather, are exposed to the weather and elements and also vulnerable to theft and damage. The driver will also usually be wearing gloves, which make handling of such devices and mounts more difficult. Devices mounted onto such vehicles, and their mounts, are also subject to sometimes strong vibrations during driving which can cause the position or orientation of the device/mount to inadvertently change.

There therefore remains a need for improved mounting solutions for portable electronic devices, and in particular portable navigation devices, that mitigate or reduce some of the above problems.

### SUMMARY OF THE INVENTION

According to an aspect of the present invention, there is provided a mount assembly for a portable electronic device, comprising:

a first component including a receiving surface arranged to engage against a surface of a portable electronic device;

a second component including a mounting surface arranged to engage with a carrier;

a third component including a first surface that cooperates with a surface of the first component to allow the first component to rotate relative to the third component; and a second surface that cooperates with a surface of the second component to allow the third component to tilt relative to the second component; and

a locking member connecting the first and third components such that the first component moves with the third component when the third component tilts relative to the second component and that, when in a locked position, is arranged to prevent the relative movement between the first, second and third components.

The first surface of the third component is preferably a profiled, e.g. striated, surface that engages with a corresponding profiled, e.g. striated, surface of the first component to allow the first component to rotate relative to the third component. Additionally, or alternatively, the second surface of the third component is preferably a profiled, e.g. striated, surface that engages with a corresponding profiled, e.g. striated, surface of the second component to allow the third component to tilt relative to the second component. The profiled or striated surfaces enhance the engagement between the surfaces, when the locking member is in the locked position, so as to prevent relative movement between the components when the mount assembly is used in a situation where there can be large vibrational forces, such as when experienced while driving a scooter or motorcycle. Furthermore, the profiled or striated surfaces can help to provide a positive feedback to the user when moving the mount assembly into the desired as the ridges or striations on the surface interact with each as the surfaces move relative to each other.

The locking member is preferably arranged to prevent the relative movement between the first, second and third components when in the locked position by compressing the second component between the first and third components. The locking member is preferably further arranged, when in an unlocked position, or at least an untightened position, e.g. as discussed in more detail below, the locking to maintain the engagement between the cooperating surfaces of the first, second and third components, whilst allowing for the relative movement between the respective components. In other words, when the locking member is not in the locked position, the first component is allowed to rotate relative to the third component and the third component is allowed to tilt relative to the second component.

The third component preferably comprises a first portion including the first surface and a second portion including the second surface. The first portion passes through an opening in the second component, such that second portion of the third component is within a cavity formed by the second component with the second surface engaging with an interior of the second component. The first portion is preferably cylindrical, e.g. with the first (profiled) surface being formed on the end of the cylinder. The second portion includes an arcuate surface, e.g. and the second (profiled) surface is formed on the arcuate surface. The first portion of the third component is preferably arranged to contact the sides of the opening, upon the third component being tilted relative to the second component, so as to the limit the degree of tilt between the second and third components. For example, in a preferred embodiment, the plane defined by the receiving surface of the first component can be ±15° relative to plane defined by the mounting surface of the third component. The width of the opening is preferably substantially the same as the diameter (or corresponding width) of the first portion of the third component so as to restrict the movement of the third component relative to the second component, e.g. forwards and backwards along the arc defined by the arcuate surface.

The first and third components are preferably in the form of ring members that together define a bore through which the locking member is located. In other words, the locking member preferably passes through the bore in the first and third components. In a preferred embodiment, the locking member comprises a bolt that connects to a nut. A head of the bolt preferably engages with the receiving surface of the first component, and the nut preferably engages with the underside of the third component. The bore of the third component preferably includes a thread that cooperates with a thread of the bolt, such that, upon tightening of the bolt, the second component is compressed between the first and third components. The bolt can be tightened using any suitable means, such as a hex (or allen) key.

The first component preferably includes a compressible portion that engages with the second component. The compressible portion is in a compressed state when the locking member is in the locked position. The additional use of the compressible portion allows for a greater compression force to be achieved between the first and third components, and thereby allows the selected orientation of the receiving surface to the mounting surface to be maintained even when the mount assembly is subjected to significant vibration forces, e.g. as experienced when the mount assembly is used with a motorcycle, scooter or similar vehicle. The compressible portion can be made of any suitable or desired material, but preferably is an elastomer, such as rubber. As will therefore be appreciated, the compressible portion functions as an O-ring between the first and second components of the mount assembly.

As discussed above, the second component includes a mounting surface arranged to engage with a carrier. The carrier is preferably a bar or tube, such as a mirror bar of a motorcycle or scooter. The carrier can, however, be an adapter including a bar or tube that is itself mounted to a vehicle, such as the handle bar of a motorcycle or scooter. It is also envisaged that the carrier could also be a surface, e.g. of a vehicle, to which the mounting surface of the second component is temporarily or permanently attached.

In preferred embodiments, e.g. in which the carrier is a bar or tube, the mount assembly further comprises a clamping member that is connectable to the second component, such that the carrier is positioned between the clamping member and the mounting surface of the second component, to attach the mount assembly to the carrier. In such embodiments, the clamping member is preferably connected to the second component by way of one or more screws that are arranged, when tightened, to secure the carrier between clamping member and the mounting surface of the second component.

In preferred embodiments, the first component can comprise a stopper, and the third component can comprise a projection. The stopper is arranged in such embodiments to contact the projection, upon the first component being rotated relative to the third component, so as to the limit the degree of rotation between the first and third components. This feature is particularly advantageous when the receiving surface of the first component comprises one or more resilient members that are arranged to cooperate with one or more corresponding features of the portable electronic device to connect the device to the mount assembly, e.g. a bayonet connector, and wherein the connection between the device and the mount assembly is preferably releasable by rotating the device relative to the mount assembly. As will be understood, without such a feature, if the device is connected to the mount assembly, e.g. with the device covering and preventing access to the locking member, and the locking member is not in the locked position, then a user would be unable to disconnect the device from the mount assembly since rotation of the device would just cause corresponding rotation of the first component.

A mount assembly as described herein is preferably used to mount a portable device, preferably a portable electronic device, such as a portable navigation device (PND). The invention may find use in mounting a portable electronic device that has a touch screen display. The portable electronic device may comprise a mobile phone, smart phone, PDA, portable audio system (e.g. radio player, MP3 player), multi-media player, games console, tablet computer, portable personal computer or the like.

In embodiments, the mount assembly is a passive mount, i.e. does not provide power to a portable electronic device connected to the mount assembly. It has been recognised, however, that the form factor of the mount assembly is beneficially suited for use as a wireless charging station, e.g. to provide power to a device via indicative coupling. In such embodiments, an induction coil, e.g. transmitter coil, can be positioned beneath the receiving surface of the first component, and which receives power, for example, from a vehicle power source, such as a battery. A corresponding induction coil, e.g. receiver coil, can then be positioned in the portable electronic device, which further includes a battery. An alternating electromagnetic field is generated by passing a current through the transmitter coil in the mount assembly, and the receiver coil in the portable electronic device takes power from the electromagnetic field and converts it back into electric current to charge the battery.

The present invention in accordance with any of its further aspects or embodiments may include any of the features described in reference to other aspects or embodiments of the invention to the extent it is not mutually inconsistent therewith.

Advantages of these embodiments are set out hereafter, and further details and features of each of these embodiments are defined in the accompanying dependent claims and elsewhere in the following detailed description.

### BRIEF DESCRIPTION OF THE FIGURES

Preferred embodiments will now be described by way of example only and with reference to the accompanying drawings in which:

FIG. 1 is a sectional view of a mount assembly according to an embodiment of the invention;

FIG. 2 is a sectional view of the mount assembly of FIG. 1 looking along axis A-A;

FIG. 3 is a closer sectional view of the mount assembly of FIG. 1, wherein the receiving surface is parallel to the mounting surface;

FIG. 4 is a closer sectional view of the mount assembly of FIG. 1, wherein the receiving surface is tilted relative to the mounting surface;

FIG. 5 shows the underside of the first component of the mount assembly;

FIG. 6 shows the underside of the second component of the mount assembly;

FIG. 7 shows a perspective view of the upper surfaces of the third component of the mount assembly;

FIG. 8 shows a front view of a device that can be attached to a mount assembly according to an embodiment of the invention;

FIG. 9 shows the rear of the device of FIG. 8;

FIG. 10 shows the device of FIG. 8 mounted to a mount assembly according to an embodiment of the invention; and

FIG. 11 shows a mount assembly according to another embodiment of the invention that functions as a wireless charging station for a device that is attached to the mount assembly.

### DETAILED DESCRIPTION OF THE FIGURES

FIG. 1 shows a sectional view of a mount assembly 200 according to an embodiment of the present invention, while FIG. 2 shows a sectional view along the axis A-A shown in FIG. 1.

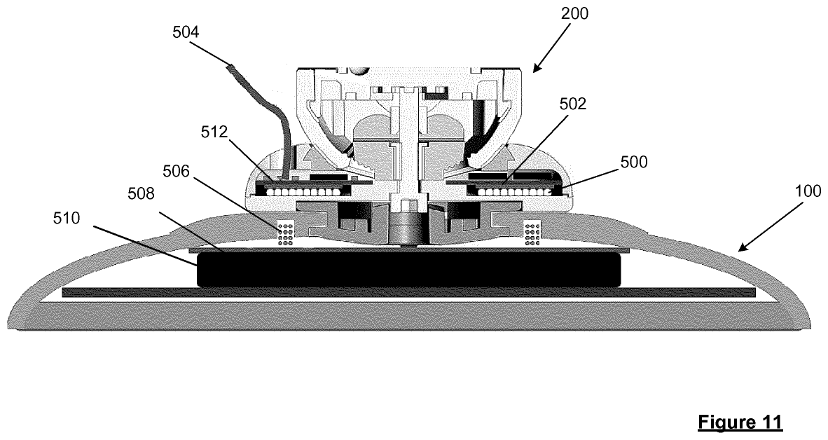

The mount assembly 200 comprises a receiving surface 10 arranged to engage against a surface of a portable electronic device 100. As will be discussed in more detail below, the receiving surface 10 includes a set of resilient members or projections 40 that fit into slots 104 (as shown in FIG. 9), so as to form a bayonet connector. The mount assembly 200 further includes a mounting surface 30 arranged to engage with a carrier 304, for example the mirror bar or handle bar of a motorcycle, scooter or the like. Any suitable mounting arrangement may be used, for example a two-part clamp that clamps around the mirror bar defining a passage for the mirror bar and wherein the two parts can then be bolted together to secure the mount assembly to the mirror bar. Alternative mounting means may also be provided for fixing to the mirror bar or, indeed, to any other carrier, for example to the handle bar of a motor bike or scooter or the like. The mounting component may, for example, be a simple ring that can be fitted over a mirror bar, handle bar, etc. or any other clamp or fastening arrangement. In the example shown in FIGS. 1 and 2, however, the mount assembly 200 further includes a clamping member 300 that has a corresponding mounting surface, so as to clamp the mount assembly 200 to the carrier 304. The receiving surface 10 is formed on a first component 1 and the mounting surface 30 is formed on a second component 2; the mount assembly 200 further including a third component 3 that cooperates with first and second components, as discussed in more detail below, such that the receiving surface (and thus any attached device) can be rotated and tilted relative to the mounting surface to allow for the angle of view of the device to be adjusted and/or better access to the device.

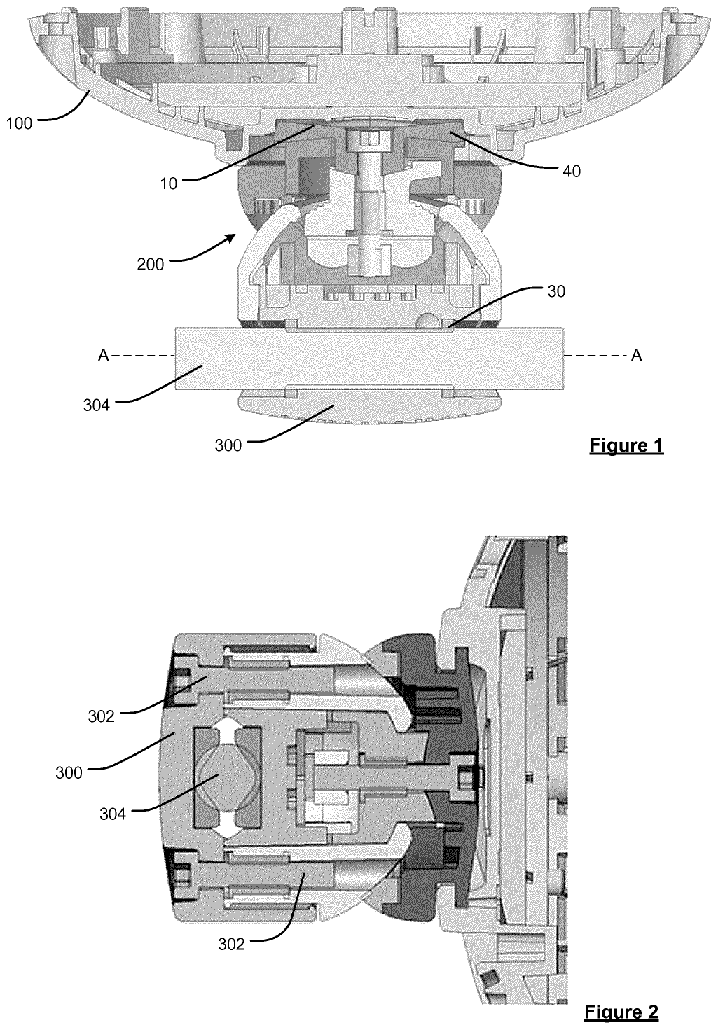

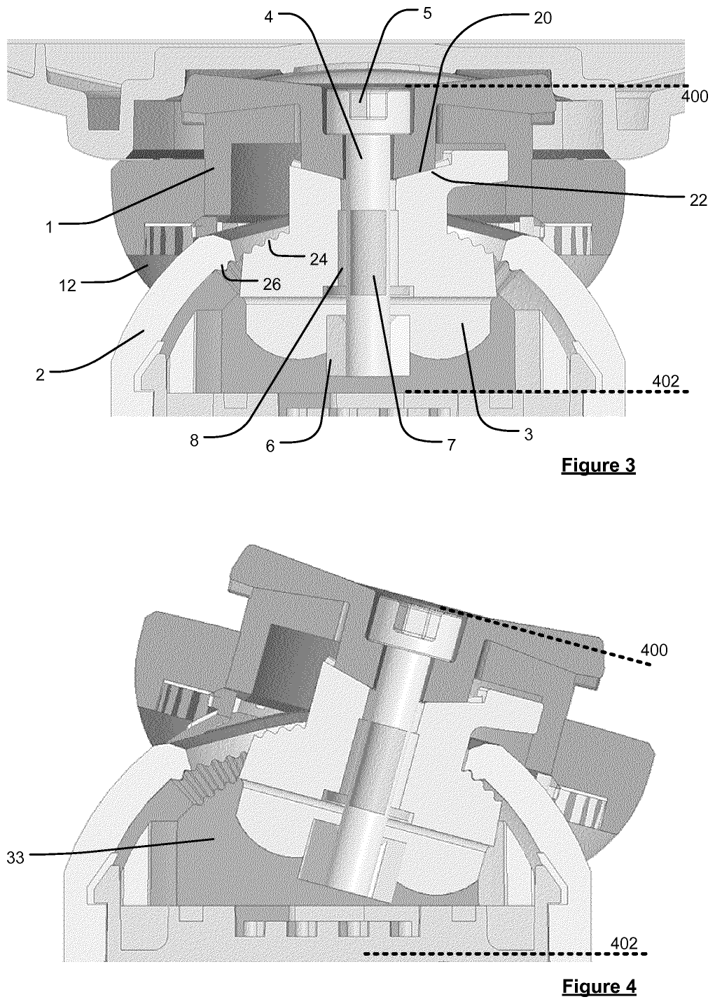

FIG. 3 shows a closer sectional view of the mount assembly 200 in which the plane 400 defined by the receiving surface 10 is parallel to the plane defined by the mounting surface 30. FIG. 4 shows a similar view, but wherein the plane 400 is angled or tilted relative to the plane 402.

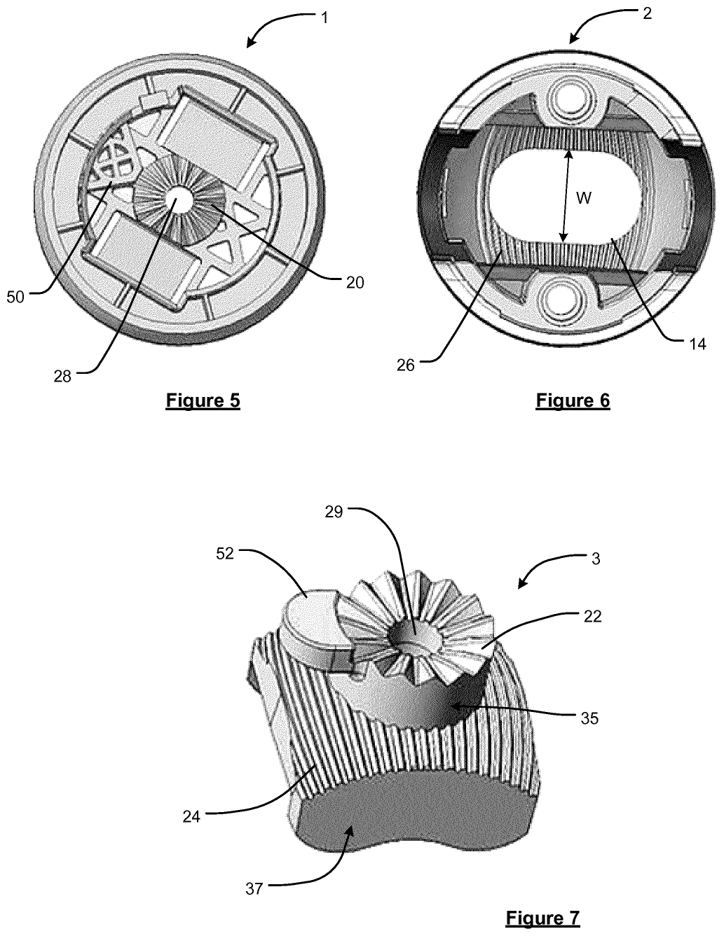

The first component 1, which is shown in isolation in FIG. 5, is formed as a ring member and thus includes a central bore 28. The receiving surface 10 with its resilient members for connecting to the device 100 is formed on a first (upper) surface of the component. An opposing (lower) surface of the first component 1 includes a profiled or striated surface 20 that engages with a corresponding profiled or striated surface 22 of the third component 3 (as shown in FIG. 3). The engagement between the two surfaces allows the first component 1 to rotate relative to the third component, and thereby allow a device 100 to rotate relative to the mount assembly 200.

The second component 2, which is shown in isolation in FIG. 6, is formed with a cavity 33 in which a portion of the third component 3 is located. In particular, the second component includes an opening 14 and a profiled or striated surface 26 on the inner surface of the component. The profiled or striated surface 26 of the second component 2 engages with a corresponding profiled or striated surface 24 of the third component 3 (as show in FIG. 3). The engagement between the two surfaces allows the third component 3 to tilt relative to the second component, and, due to the connection between the first and third components, thereby allows a device 100 to tilt relative to the mount assembly 200. This relative tilting of the second and third components can be seen in FIG. 4.

The third component 3, which is shown in isolation in FIG. 7, therefore includes a first cylindrical portion 35 that extends through the opening 14 in the second component 2 and a second, arcuate portion 37 that resides in the cavity 33 of the second component. The third component 3 is also formed as a ring member and this includes a central bore 29. As will be seen the opening 14 in the second component has a width W substantially equal to the diameter of the cylindrical portion 35 of the third component, so as to restrict the degree of freedom of movements of the third component 3 relative to the second component 2. In other words, the opening 14 acts as a guide for the third component 3.

As shown in FIG. 3, a bolt 4 extends through the bore 28 in the first component 1 and the bore 29 in the third component 3, such that the first component tilts in conjunction with the third component, when the surface 24 moves along the surface 26. The bolt 4, when in an untighten or unlocked state, therefore ensures that the engagement between the first, second and third components is maintained, whilst still allowing the first component 1 to rotate relative to the third component 3 and the third component 3 to tilt relative to the second component 2. The bolt 4 is inserted into a nut 6 on the underside of the third component 3, and tightened by a user, e.g. by means of a tool such as a hex key. The bolt 4 further includes a thread 7 that cooperates with a thread 8 on the inside of the bore defined in the third component, such that rotation of the bolt causes the first and third components to be compressed towards each other. As will be appreciated, the second component 2 is captured between the first and third components 1,3, such that, when the bolt is in a tighten or locked state, the first, second and third components are locked together, i.e. are not able to move relative to one another, thereby fixing the selected degree of rotation and tilt.

In the embodiments shown, the cooperating surfaces of the components 1, 2, 3 are provided with a ridged profile or have a series of striations. This can be seen clearly in FIGS. 5, 6 and 7. These striations allow for relative movement (when the bolt is not tightened), but also allow for a relative secure final holding of the components relative to each other when the bolt is tightened. This has particular advantages in applications where the mount assembly is mounted on a motorcycle or scooter or the like, since the mount assembly will be subject to large vibrations during driving. The engagement of the striated surfaces avoids the receiving surface from inadvertently moving out of its rotated position due to these vibrations. The striated surface also provides a positive feedback to the user when moving the mount assembly into the desired position as the ridges or the striated surface will provide a positive ‘click’ that the user can feel/hear to ensure the position of the components. The heights of the striations can be varied according to the desired used of the assembly to e.g. provide a greater feedback to the user and greater holding force.

The further enhance the compression force holding the first, second and third components in position, when the mount assembly 200 is locked in position by tightening the bolt 4, the first component 1 includes a compressible outer sleeve 12 of a material such as rubber that functions as an O-ring. As can be seen, for example, in FIG. 3, the sleeve 12 is position on the underside of the first component and engages with the upper surface of the second component. Therefore, as the bolt 4 is tightened to lock the mount assembly 200 in position, the sleeve 12 will be compressed to help prevent movement of the first component 1 relative to the second component 2.

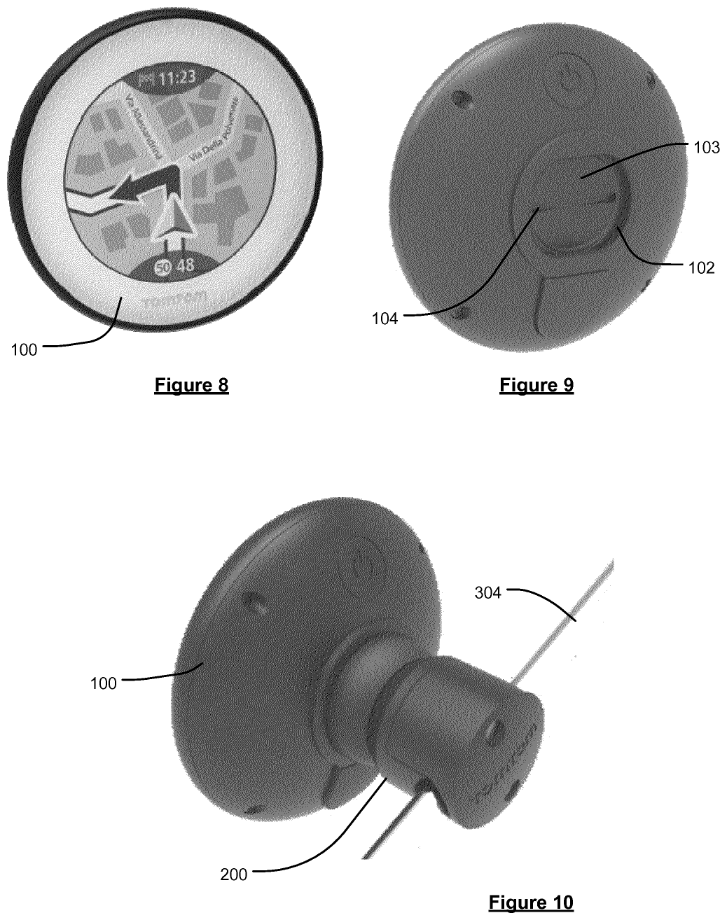

The mount assembly 200 can be used to hold any desired portable electronic device 100. An exemplary device is shown in FIGS. 8, 9 and 10. FIG. 8 shows the front of the device 100, which is this instance is a touch screen display device that displays images to provide navigation instructions for guiding a user along a predetermined route, wherein the images are provided over a wireless communication channel from a remote device, such as a smartphone. The device 100 is circular, since this means that the device has a shape similar to a mirror of a motorcycle, scooter, etc. As well as being aesthetically pleasing when such a round device is mounted along with the mirror on the mirror bar or on the handle bar, the circular display and mount device has a relatively unobtrusive appearance, which may deter thieves, etc. Furthermore, the circular design provides no sharp edges or corners which might cause damage or injury. This circular design is, however, merely one design option and the mount assembly can be configured to receive any other shaped device as desired, such as rectangular or square. The rear of the device 100, as is shown in FIG. 9, includes a mounting surface 103 that engages with receiving surface 10 of the mount assembly 200. The mounting surface 103 includes slots or notches 104 into which the resilient members or projections 40 on the receiving surface 10 engage when the device 100 is secured to the mount assembly 200. In this instance, the device 100 is secured in place on the receiving surface 10 through rotation of the device 100 relative to the mount assembly 200, e.g. by 90°. The device 100 including guiding features 102 that facilitate the rotation of the device and cause the projections 40 to align with the slots 104 when the device 100 is suitable positioned relative to the mount assembly 200. As will therefore be appreciated the device 100 is preferably connected to the mount assembly 200 through the use of a bayonet connection. FIG. 10 shows the device 100 when secured to the mount assembly 200, which is in turn connected to a mirror bar 304 of a scooter.

Due to the manner in which the device 100 is rotated relative to the mount assembly 200 in order to attached the device, the mount assembly preferably includes features that limit the rotation of the first component 1 relative to the third component 3. These features, which comprise a stopper 50 on the underside of the first component 1 (as shown in FIG. 5) and a projection 52 on the third component 3 (as shown in FIG. 7), allow the device 100 to be removed from the mount assembly 200 in the event that a user attaches the device without mistakenly first tightening the bolt 4 and thereby locking the mount assembly 200 in position. As will be appreciated, when the first and third components rotate relative to each, at some point the projection 32 will contact the stopper 50, thereby preventing further rotation of the components in that direction of rotation. At this point, the device 100 can be rotated relative to the mount assembly 200, and thus disengaged from the mount assembly 200.

It will be understood from the above that the mount assembly 200 has a relatively low profile and is also able to withstand forces acting on the assembly, e.g. during driving, to prevent vibration of the device/display. The mount can also be easily installed by a layperson with minimum tooling and it is also easy to attach and remove the device to the mount.

A further embodiment of the mount assembly 200 is shown in FIG. 11, wherein the mount assembly 200 is arranged to function as a wireless charging station for the device 100. The form of the mount assembly is particularly suited for this task in that the distance between the transmitter coil 500 in the mount assembly 200 and the corresponding receiver coil 506 in the device 100 is relatively small. As known in the art, wireless charging is performed by generating an alternating electromagnetic field by passing a current through the transmitter coil 500 in the mount assembly 200, and the receiver coil 506 in the portable electronic device 100 takes power from the electromagnetic (EM) field and converts it back into electric current to charge a battery 510.

As can be seen in FIG. 11, the transmitter coil 500 is a flat coil positioned beneath the receiving surface 10 of the mount assembly 200 with the turns of the coil being in a plane parallel to that of the receiving surface 10. The coil 500 is positioned on top of a ferrite shield 502 to enhance the generated EM field. The power to generate the EM field is provided by wire 504 that is, for example, attached to a power source, such as a battery, of a vehicle, such as a motorcycle, scooter or similar vehicle. FIG. 11 also shows a printed circuit board (PCB) 512 that is used to control the generation of the EM field. The receiver coil 506 is a hollow coil positioned around the mounting surface 103 of the device 100 with the turns of the coil extending along an axis normal to the plane defined by the receiving surface 10 of the mount assembly 200 (and thus also the mounting surface 103). The coil 506 is again positioned on top of a ferrite shield 508.

As will be appreciated by those skilled in the art, various changes and modifications can be made to the above described embodiments whilst still falling within the scope of the present invention as set forth in the accompanying claims.

1. A mount assembly for a portable electronic device, comprising:
a first component including a receiving surface arranged to engage against a surface of a portable electronic device;
a second component including a mounting surface arranged to engage with a carrier;
a third component including a profiled first surface that cooperates with a corresponding profiled surface of the first component to allow the first component to rotate relative to the third component; and a second surface that cooperates with a surface of the second component to allow the third component to tilt relative to the second component; and
a locking member connecting the first and third components such that the first component moves with the third component when the third component tilts relative to the second component and that, when in a locked position, is arranged to prevent the relative movement between the first, second and third components.

2. (canceled)

3. The mount assembly of claim 1, wherein the second surface of the third component is a profiled surface that engages with a corresponding profiled surface of the second component to allow the third component to tilt relative to the second component.

4. The mount assembly of claim 1, wherein the locking member is arranged to prevent the relative movement between the first, second and third components when in the locked position by compressing the second component between the first and third components.

5. The mount assembly of claim 1, wherein the third component comprises a first portion including the first surface and a second portion including the second surface, and wherein the first portion passes through an opening in the second component, such that second portion of the third component is within a cavity formed by the second component with the second surface engaging with an interior of the second component.

6. The mount assembly of claim 5, wherein the first portion of the third component is arranged to contact the sides of the opening, upon the third component being tilted relative to the second component, so as to the limit the degree of tilt between the second and third components.

7. The mount assembly of claim 1, wherein the first component includes a compressible portion that engages with the second component, and wherein the compressible portion is in a compressed state when the locking member is in the locked position.

8. The mount assembly of claim 1, wherein the first and third components are in the form of ring members defining a bore, and wherein the locking member passes through the bore in the first and third components.

9. The mount assembly of claim 8, wherein the locking member comprises a bolt that connects to a nut, a head of the bolt engaging with the receiving surface of the first component, and the nut engaging with the underside of the third component, and wherein the bore of the third component includes a thread that cooperates with a thread of the bolt, such that, upon tightening of the bolt, the second component is compressed between the first and third components.

10. The mount assembly of claim 1, further comprising a clamping member that is connectable to the second component, such that the carrier is positioned between the clamping member and the mounting surface of the second component, to attach the mount assembly to the carrier.

11. The mount assembly of claim 10, wherein the clamping member is connected to the second component by one or more screws that are arranged, when tightened, to secure the carrier between clamping member and the mounting surface of the second component.

12. The mount assembly of claim 1, wherein the first component comprises a stopper, and the third component comprises a projection, and wherein the stopper is arranged to contact the projection, upon the first component being rotated relative to the third component, so as to the limit the degree of rotation between the first and third components.

13. The mount assembly of claim 1, wherein the receiving surface of the first component comprises one or more resilient members that are arranged to cooperate with one or more corresponding features of the portable electronic device to connect the device to the mount assembly.

14. The mount assembly of claim 13, wherein the connection between the device and the mount assembly is releasable by rotating the device relative to the mount assembly.

15. The mount assembly of claim 1, wherein the carrier is a bar or tube, such as a mirror bar of a motorcycle or scooter.
